(19) United States
(12) Patent Application Publication
(10) Pub. No.: US 2026/0312944 A1
(43) Pub. Date: Oct. 8, 2026

(54) MEMBER-BASED ELIGIBILITY VERIFICATION

(71) Applicant: CU DIRECT CORPORATION, Irvine, CA (US)

(72) Inventor: Darren Robert Lorentz, Parker, CO (US)

(21) Appl. No.: 19/170,577

(22) Filed: Apr. 4, 2025

(51) Int. Cl. H04L 9/40; G06Q 40/03

(52) U.S. Cl. CPC H04L 63/08; G06Q 40/03

(57) ABSTRACT

A computer-implemented method, computer program product, and a computer system for determining eligibility based on membership is provided. In some embodiments, the computer-implemented method includes receiving a set of one or more records associated with an applicant. The disclosed embodiments further include generating a key for the applicant based, at least in part, on extracted data elements from the set of one or more records and determining membership status of the applicant to one or more organizations by comparing the generated key against a set of keys in a database. The disclose embodiments further include determining options for the applicant based on the membership status.

### BACKGROUND

The verification of membership status in credit unions poses significant challenges for loan agencies, such as a retail finance department, particularly when applicants seek to apply for loans from different lending providers. Credit unions operate as member-owned cooperatives, each with specific membership criteria that applicants must meet to qualify for services. This unique structure introduces complexities in verifying membership status, especially when applicants apply for loans outside their primary credit union.

One of the primary challenges loan agencies face is the diversity of membership criteria across different credit unions. These criteria may include geographical restrictions, employment affiliations, or associations with certain organizations. Consequently, when loan agency seeks a loan for an applicant from across a broad spectrum of lenders such as credit unions, the loan agency must ensure that the applicant meets the membership requirements of the originating credit union. This verification process may be cumbersome, time consuming and prone to errors, leading to delays in loan processing and potential dissatisfaction for applicants.

Another significant issue is the lack of standardized data access and documentation practices among credit unions. As standard practice, each credit union typically maintains its own membership database, which may vary in terms of format, comprehensiveness, and accessibility. This inconsistency complicates the task for loan agencies attempting to verify membership, as they must navigate disparate systems and potentially deal with incomplete or outdated information. Furthermore, privacy regulations impose additional constraints on accessing and sharing member data, necessitating careful compliance measures that can slow down the verification process.

As such, techniques for a unified solution that protects sensitive data and ensures the integrity of secure communications within dynamic, decision-oriented environments for membership status verification would offer improvements to the field of member identification systems.

### SUMMARY

Aspects of the present disclosure provide a computer-implemented method for determining eligibility based on membership. In some embodiments, the computer-implemented method includes receiving a set of one or more records associated with an applicant. The computer-implemented method further includes generating a key for the applicant based, at least in part, on extracted data elements from the set of one or more records and determining, by the one or more processors, membership status of the applicant to one or more organizations by comparing the generated key against a set of keys in a database. The computer-implemented method further includes determining options for the applicant based on the membership status.

Aspects of the present disclosure further provide a computer program product for determining eligibility based on membership. In this embodiment a computer program product includes one or more processors and one or more computer readable storage media that when executed by the one or more processors, cause program instructions stored on the one or more computer readable storage media to receive a set of one or more records associated with an applicant, generate a key for the applicant based, at least in part, on extracted data elements from the set of one or more records, determine membership status of the applicant to one or more organizations by comparing the generated key against a set of keys in a database, and determine options for the applicant based on the membership status.

Aspects of the present disclosure further provide a computer system for determining eligibility based on membership. In this embodiment, a computer system includes one or more processors, one or more computer readable storage media, and program instructions stored on the one or more computer readable storage media that when executed by the one or more processors, cause the program instructions to receive a set of one or more records associated with an applicant, generate a key for the applicant based, at least in part, on extracted data elements from the set of one or more records, determine membership status of the applicant to one or more organizations by comparing the generated key against a set of keys in a database, and determine options for the applicant based on the membership status.

### BRIEF DESCRIPTION OF THE DRAWINGS

FIG. 1 is a functional block diagram illustrating a computing environment, in accordance with various embodiments of the systems and methods disclosed herein;

FIG. 2 is a flowchart depicting an example of operational steps for determining eligibility based on membership, in accordance with various embodiments of the systems and methods disclosed herein;

FIG. 3 depicts a block diagram of components of the computing systems of FIG. 1, in accordance with various embodiments of the systems and methods disclosed herein; and

FIG. 4 depicts a block diagram illustrating an alternate computing environment, in accordance with various embodiments of the systems and methods disclosed herein.

### DETAILED DESCRIPTION

Aspects of the present disclosure recognize and address current problems loan agencies face when applicants seek loans from different lending providers. The verification of membership status in credit unions may pose significant challenges for loan agencies, particularly when assessing an applicant's member status from a large number of potential credit unions. This is because specific membership criteria may vary for each respective credit union. This unique structure introduces complexities in verifying membership status, especially when applicants apply for loans outside their primary credit union. Consequently, when an applicant seeks a loan from a credit union, the loan agency must verify whether or not the applicant is a current member at the credit union. This verification process may be cumbersome and prone to errors, leading to delays in loan processing and potential dissatisfaction for applicants.

Another significant issue is the lack of standardized data access and documentation practices among credit unions. Each credit union typically maintains its own membership database, which may vary in terms of format, comprehensiveness, and accessibility. This inconsistency complicates the task for loan agencies attempting to verify membership, as they must navigate disparate systems and potentially deal with incomplete or outdated information. Furthermore, privacy regulations impose additional constraints on accessing and sharing member data, necessitating careful compliance measures that may slow down the verification process.

Recognizing these technical deficiencies, embodiments of the systems and methods disclosed herein may be implemented to provide technical solutions that provide a unified solution that may streamline the verification of credit union membership status for applicants seeking loans from different providers and that may standardize the process. For example, aspects of the systems and methods disclosed herein may be implemented to provide a solution that determines or confirms the applicant's membership across various lending platforms and reduces the complexity of verifying membership status. Specifically, aspects of the systems and methods may be implemented to provide a unified solution that generates a key unique to the applicant based on extracted data elements from a set of records associated with the applicant and may be independently verified by a loan agency using the same set of records without having to share personally identifiable information. These technical solutions depart from conventional verification and authentication techniques and reduce the complexity of typical authentication techniques as discussed in greater detail later in this Specification.

Aspects of the systems and methods may be implemented to provide other technical benefits that protects sensitive data and ensures the integrity of secure communications within dynamic, decision-oriented environments for determining current member status from a large number of organizations (e.g., credit unions) in a short period of time. For example, aspects of the systems and methods may be configured to transmit the generated key that is unique to the applicant without the requirement of encryption and may independently verify the member key without having to share personally identifiable information between a credit union and a loan agency.

These technical solutions confer technological improvement to the field of membership verification. By adopting a standardized approach, member verification systems used by loan agencies are programmatically improved by reducing the complexity of member verification systems, increasing their speed and responsiveness, improving their efficiency and allowing a uniform and standardized approach. This increases the accuracy and efficiency of member verification thereby reducing overall resource usage and processing times.

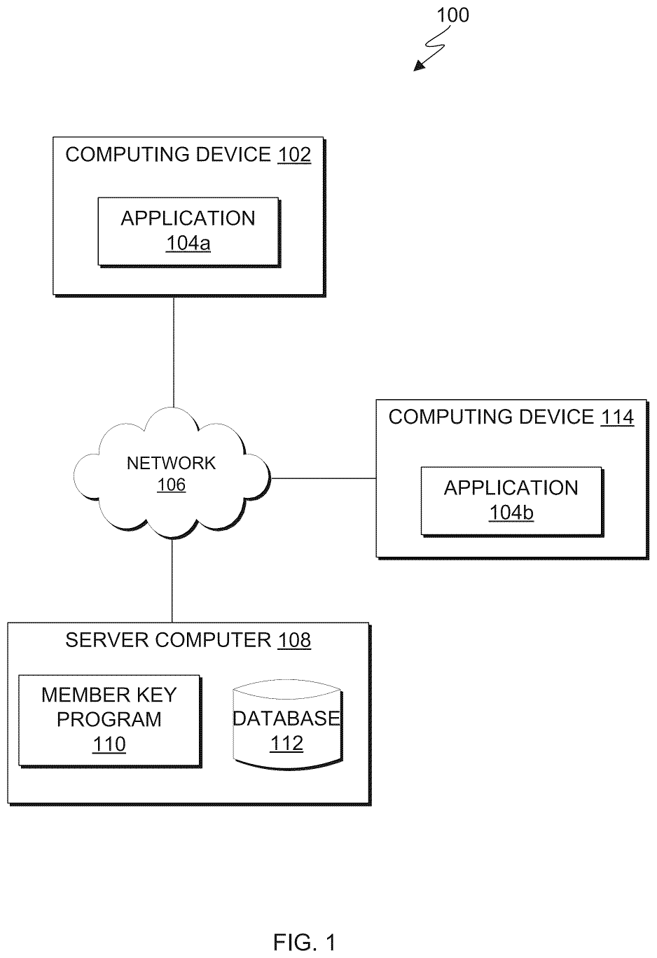

FIG. 1 is a functional block diagram illustrating an example computing environment, generally designated computing environment 100, in accordance with various embodiments of the systems and methods disclosed herein. FIG. 1 provides only an illustration of one implementation and does not imply any limitations with regard to the environments in which different embodiments may be implemented. Many modifications to the depicted environment may be made by those skilled in the art without departing from the scope of the various aspects of systems and methods disclosed herein, as recited by the claims.

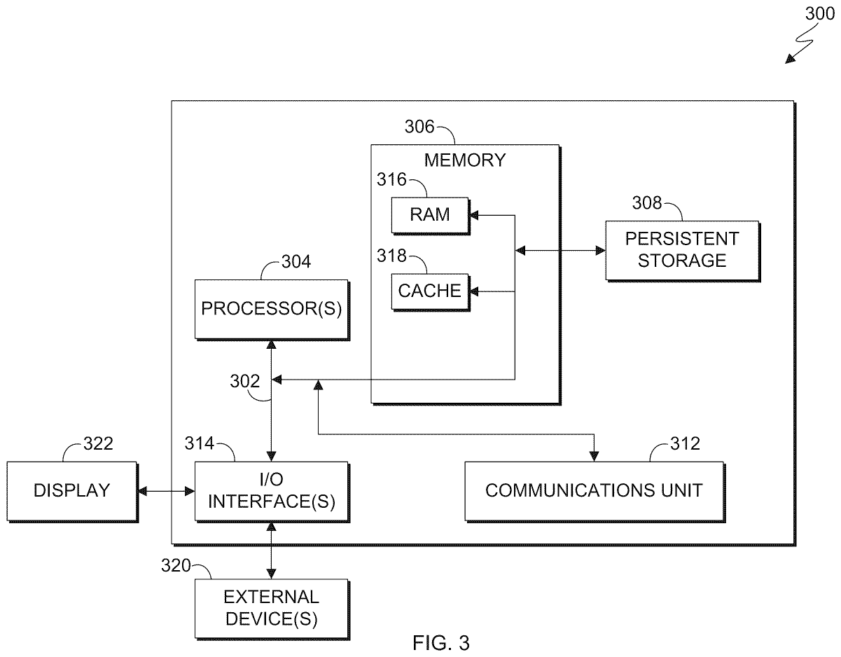

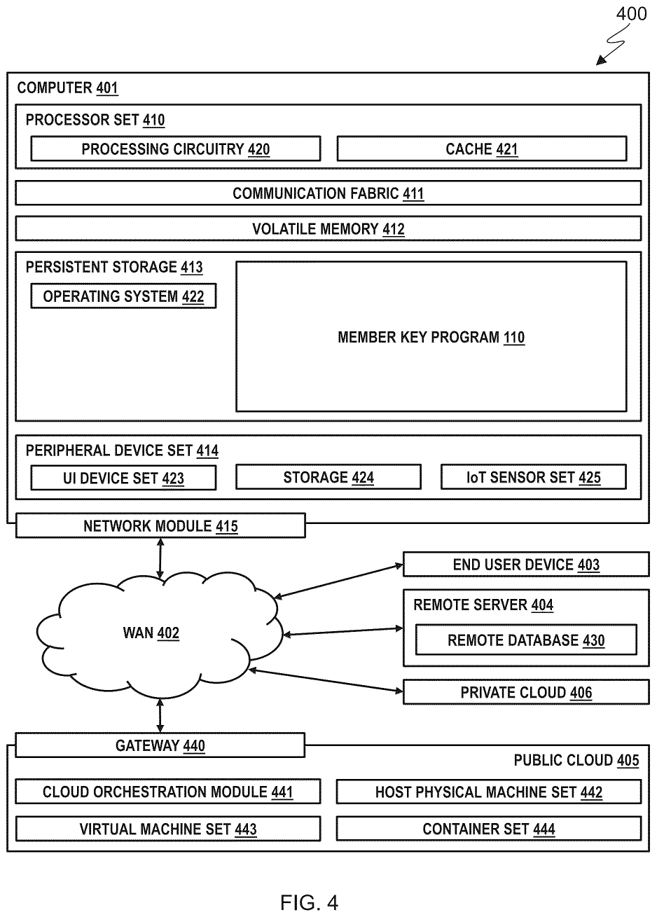

Computing environment 100 includes computing device 102, computing device 114, and server computer 108, all interconnected over network 106. Computing device 102, computing device 114, and server computer 108 may be a standalone computer device, a management server, a webserver, a mobile computing device, or any other electronic device or computing system capable of receiving, sending, and processing data. In other embodiments, computing device 102, computing device 114, and server computer 108 may represent a server computing system utilizing multiple computers as a server system, such as in a cloud computing environment, as depicted and described in further detail with respect to FIG. 4. In another embodiment, computing device 102, computing device 114, and server computer 108 may be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, computing device 102, computing device 114, and server computer 108 each represent a computing system utilizing clustered computers and components (e.g., database server computers, application server computers, etc.) that act as a single pool of seamless resources when accessed within computing environment 100. In some embodiments, computing device 102, computing device 114, and server computer 108 are a single device. Computing device 102, computing device 114, and server computer 108 may include internal and external hardware components capable of executing machine-readable program instructions, as depicted and described in further detail with respect to FIG. 3.

Computing device 102 is a digital device associated with a credit union and users thereof and includes application 104a. Application 104a communicates with server computer 108 to access member key program 110 (e.g., using TCP/IP) and database 112. Application 104a may further communicate with member key program 110 to generate a key for an applicant based, at least in part, on extracted data elements from a set of one or more records, transmit one or more lists comprising generated member keys, determine membership status of the applicant, and determine options for the applicant based on the membership status, as discussed in greater detail below. In general, application 104 may be implemented using a browser and web portal or any program that may interface with or otherwise access member key program 110. In some embodiments, application 104 may transmit instructions to member key program 110 to send one or more files comprising generated member keys to computing device 114 (e.g., a loan agency).

Computing device 114 is a digital device associated with a lending agency and users thereof and includes application 104b. Applications 104a and 104b may be different instances of the same program. Application 104b communicates with server computer 108 to access member key program 110 (e.g., using TCP/IP) to similarly access member key program 104 to generate a key for an applicant based, at least in part, on extracted data elements from a set of one or more record, determine membership status of the applicant to one or more organizations and determine options for the applicant based on the membership status to the one or more organizations.

Network 106 may be, for example, a telecommunications network, a local area network (LAN), a wide area network (WAN), such as the Internet, or a combination of the three, and may include wired, wireless, or fiber optic connections. Network 106 may include one or more wired and/or wireless networks that are capable of receiving and transmitting data, voice, and/or video signals, including multimedia signals that include voice, data, and video information. In general, network 106 may be any combination of connections and protocols that will support communications among computing device 102, computing device 114, and server computer 108, and other computing devices (not shown) within computing environment 100.

Server computer 108 is a digital device that hosts member key program 110 and database 112. In this embodiment, member key program 110 and database 112 reside on server computer 108. In other embodiments, member key program 110 and/or database 112 may be stored locally on computing device 102 or computing device 114. Other embodiments include member key program 110 and/or database 112 being local to or virtually part of computing device 114. In yet other embodiments, an instance of member key program 110 and/or database 112 may be stored on computing device 102 or computing device 114 and may communicate with another instance of member key program 110 residing on server computer 108. In some embodiments, member key program 110 may be a stand-alone program on a computing device. In certain aspects of the systems and methods disclosed herein, member key program 110 and database 112 may be cloud based, utilizing multiple computing devices, made available as a software as a service (SaaS), as part of an infrastructure as a service (IaaS) system, as part of a platform as a service (PaaS), etc.

Member key program 110 provides a unified, end-to-end solution to efficiently verify membership of an applicant without having to share personally identifiable information between a credit union and a loan agency. In this embodiment, member key program 110 provides this solution by generating a unique key for an applicant based on a set of disparate records associated with the applicant. One or more records from disparate sources that are associated with the applicant that may be used to generate a unique member key include a set of loan application documents (e.g., identification documents, income verification documents, credit information documents, asset documentation documents, debt information, one or more personal references, etc.). The one or more records may further include one or more host records (e.g., a set of membership documents for a respective credit union).

In this embodiment, member key program 110 extracts one or more data elements from the one or more records that may be found both in the host record and the loan application documents to generate a unique key for the applicant. For example, in response to receiving a set of one or more records associated with the applicant, member key program 110 may extract data elements from the set of one or more records that are unique to the applicant. In this embodiment, member key program 110 extracts data elements using natural language processing, patterning matching, and text parsing techniques. In other embodiments, member key program 110 may extract data elements using one or more machine learning modules (not shown) and other data extraction methods (e.g., optical character recognition, application programming interfaces for text analysis, etc.) to extract data elements from the set of one or more records.

Extracted data elements, as used herein refers to a set of information unique to the user that may be found in one or more disparate records. For example, member key program 110 extracts an applicant's street address, date of birth, and social security number as the data elements from a set of one or more disparate records. In this embodiment, member key program 110 utilizes data elements that are in the loan application record (e.g., a set of one or loan application documents) as well as the host record (e.g., a set of membership documents for a respective credit union) to generate the unique key. In this embodiment, member key program 110 does not utilize applicant's first name, last name or telephone number to minimize generating the same key for multiple members. In other embodiments, member key program 110 may extract other information and respective data elements unique to the user that is specific enough to minimize the probably of repeating keys between consumers and lenders, except for those consumers that are members of more than one of those institutions (e.g., credit unions).

Member key program 110 may then generate a unique key for the applicant that reflects membership to an organization (e.g., a credit union) based on the extracted data elements from the set of one or more records. In this embodiment, member key program 110 generates a unique ten character key by randomly selecting and ordering characters of the extracted information unique to the user. For example, member key program 110 identifies categories of data elements from the extracted information (e.g., street address, date of birth, social security number), identifies characters for each identified category (e.g., 4123 McLane Street, Nowhere, D.C. 20043), selects a subset of the identified characters (e.g., the second and third letters of the applicant's street address), and orders the selected subset of identified characters.

For example, where member key program 110 extracts an applicant's street address, date of birth, and social security number, member key program 110 selects the sixth and ninth digits of the user's social security number (e.g., “3” and “8”) as the first and second character of the member key, the first character of the applicant's street address (e.g., “4”) as the third character of the member key, the second and third letters of the applicant's street address (e.g., “cL”) as the fourth and fifth characters of the member key, the last two digits of the applicant's zip code (e.g., “43”) as the sixth and seventh characters of the member key, the applicant's day of birth (e.g., “02”) as the eighth and ninth characters of the member key and the last digit of the year in applicant's date of birth (e.g., “4”) as the tenth character of the member key. In this manner, member key program 110 generates the following ten character member key: ‘384cL43024’. In other embodiments, member key program 110 may utilize one or more other techniques to selectively generate a random order of ten characters from the extracted information unique to the user.

In some embodiments, member key program 110 may generate additional keys for a member to indicate a secondary status based on an ordered combination of a subset of characters identified from the extracted data elements. For example, member key program 110 may generate a second unique member key for the member by adding additional characters to designate a secondary status. A secondary status refers to an additional membership designation. Examples of a secondary status include designations based on a number of years the member has had an account with a respective credit union, amount of business the applicant has done with the credit union, amount of losses the applicant has with the credit union, or any other designation helpful to determining potential terms for the applicant.

Member key program 110 may then determine membership status of the applicant utilizing the generated member key. In this embodiment, member key program 110 determines membership status to one or more organizations (e.g., credit unions) by comparing the generated member key against a set of keys in a database (e.g., database 112) and locating an identical key in the set of keys in the database to the generated key for the applicant. In response to determining that the generated member key for the applicant does not match to any key in the set of keys in the database, member key program 110 determines that the applicant is not a member of the organization. In this manner, member key program 110 may verify membership status of an applicant to an organization having a high degree (e.g., 90%) of matching accuracy while eliminating the risk of compromising a member's personally identifiable information.

Member key program 110 may then determine options for the applicant based on the membership status. In this embodiment, member key program 110 may determine eligibility and terms for the applicant based on the membership status of the applicant with a credit union. For example, in response to determining that an applicant is a member of a credit union, member key program 110 may identify membership requirements of the credit union an applicant's eligibility, options, and terms.

In this embodiment, the set of keys in the database may be generated by the credit union utilizing computing device 102 on a nightly basis and may send list of generated keys to a database of the loan agency. In other embodiments, member key program 110 may receive one or more documents or records associated with a credit union member and generate a respective key for each member of the credit member. In response to receiving a set of records of an applicant (e.g., a loan application), computing device 114 utilizing member key program 110 may then generate a respective key for the applicant and determine membership status of the applicant by comparing the generated key against a set of keys in a database (e.g., database 112) and locating an identical key in the set of keys in the database to the generated key for the applicant. Responsive to locating the identical key in the set of keys, member key program 110 may verify membership of the applicant to an organization (e.g., a credit union). In instances where member key program 110 cannot locate the identical key in the set of keys stored in the database, member key program 110 determines that the applicant is not a member of the organization. In this manner, member key program 110 provides a unified, end-to-end solution to efficiently verify membership of an applicant without having to share personally identifiable information between a credit union and a loan agency.

In this embodiment, database 112 functions as a repository for stored content. In this embodiment, stored content refers to one or more generated member keys. In some examples, a list of the one more generated member keys may be stored as a CSV file. Database 112 may reside on a cloud infrastructure and may store additional information associated with the user. In some embodiments, database 112 may function as a repository for one or more files containing information associated with a user such as membership information, loan application documents, etc.

In general, database 112 may be implemented using any non-volatile storage media known in the art. For example, database 112 may be implemented with a tape library, optical library, one or more independent hard disk drives, or multiple hard disk drives in a redundant array of independent disk (RAID). In this embodiment database 112 is stored on server computer 108. In other embodiments, database 112 may be stored on other computing devices (not shown) or may be a combination of one or more other databases that has given permission access to member key program 110.

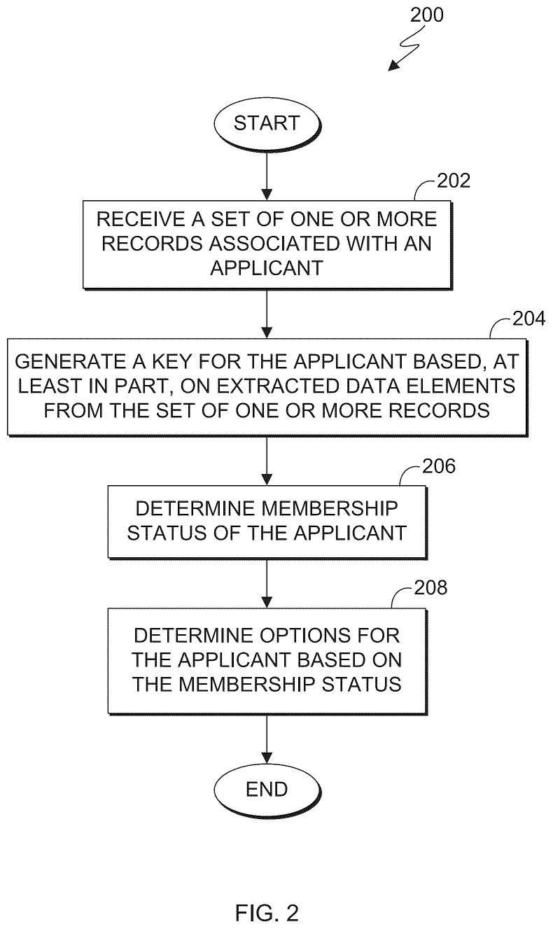

FIG. 2 is a flowchart depicting an example of operational steps for determining eligibility based on membership, in accordance with various embodiments of the systems and methods disclosed herein. For example, flowchart 200 depicts an embodiment where member key program 110 has been tasked with determining lending options for a loan applicant.

In step 202, member key program 110 receives a set of one or more records associated with an applicant. In this embodiment, member key program 110 receives one or more records associated with the applicant from a loan agency (e.g., computing device 114). A loan agency may be, for example, a finance or credit department at a retail outlet such as a retail store, automobile dealer, or other like outlet. In other implementations, the loan agency may be, for example, a broker or broker-like entity assisting applicants with obtaining financing from among a plurality of lenders. The records received may include, for example identification of the applicant (e.g., name, address(es), social security number, etc.), applicant account information, and so on.

In step 204, member key program 110 generates a key for the applicant. In some embodiments, member key program 110 generates a key for the applicant based on categories of data elements identified from extracted information (e.g., street address, date of birth, social security number). For example, member key program 150 may extract the following data elements from the received records: street address—5678 Main St., Anytown, USA 99999, date of birth—Jan. 2, 1954, and social security number—123-45-6789.

Member key program 110 may then select a subset of characters and order the subset of characters to generate a unique key that reflects membership to an organization (e.g., a credit union). The key may be a multi-character key, for example, to identify organization membership. Consider an example of a 10-character alpha-numeric key. For example, for the first and second character of the member key, member key program 110 selects the sixth and ninth digits of the user's social security number (e.g., “1” and “4”). For the third character of the member key, member key program 110 selects the first character of the applicant's street address (e.g., “5”). For the fourth and fifth characters of the member key, member key program 150 selects the second and third letters of the applicant's street address “Ma”. For the sixth and seventh characters of the member key, member key program 110 selects the last two digits of the applicant's zip code (e.g., “10”). For the eighth and ninth characters of the member key, member key program 110 selects the applicant's day of birth (e.g., “02”), and for the tenth character of the member key, member key program 110 selects the last digit of the year in the applicant's date of birth (e.g., “4”). In this manner, member key generates the following ten character member key: ‘145Ma10024’. In other embodiments, member key program 110 may utilize a randomizer to randomly select subsets of characters for each of the respective categories of data elements.

In step 206, member key program 110 determines the membership status of the applicant. In this embodiment, member key program 110 determines membership status of the applicant by comparing the generated key for the applicant against a set of keys in a database (e.g., database 112) and locating a matching (e.g., an identical) key in the set of keys in the database to the generated key for the applicant. In response to locating one or more matching keys from among the set of keys, member key program 110 may determine membership of the applicant to one or more organization(s) (e.g., a credit union) corresponding to the matching key(s). As indicated above, in some embodiments, the matching keys may be identical to the key generated for the applicant—i.e., all characters match. In other embodiments, keys may be identified as matching if they match a subset of characters, such as a subset identified as characters sufficient to connote or confirm membership. Where membership of one or more lenders is determined to exist based on key matching, the system may be further configured to message the ‘matching’ lenders to verify membership of the applicant at such lenders.

In instances where member key program 110 cannot locate a matching key in the set of keys stored in the database, member key program 110 determines that the applicant is not a member of the organizations whose key records were searched. In this manner, member key program 110 may verify membership status of an applicant to a credit union as previously discussed.

In step 208, member key program 110, member key program 110 may then determine options for the applicant based on the membership status. In some embodiments, this may include member key program 110 determining eligibility and terms for the applicant based on the membership status of the applicant with one or more credit unions.

After receiving membership/eligibility identifying matching credit unions, Application 104b may send additional applicant information to the matching credit unions, vehicle information, loan to value for the purchase, vehicle purchase agreement, or other information to be used by the applicant's credit unions to offer (or not) a loan for the purchase and to specify the terms for such loans. Member key program 110 may then put together one or more offers of financing (e.g., interest rate offers, loan amount offers, loan amortization schedules, discounts, special program offers, etc.) and present those offers to the customer/applicant. Specifically, member key program 110 may generate an interactive user interface for display on a computing device (e.g., computing device 114) that displays those offers and may dynamically adjust the one or more offers based on user interaction with the interactive user interface. For example, member key program 110 may generate a user interactive interface that displays a short-term loan and terms associated with the short term loan (e.g., loan duration, monthly payment, total interest paid, interest rate, etc.). Each term is displayed as a respective graphic icon. In response to a user selecting a graphic icon, member key program 110 may display one or more other selectable user interfaces. For example, in certain embodiments, member key program 110 may display a drop-down menu to select a list of options for the selected term. In other embodiments, member key program 110 may display other selectable user interfaces (e.g., radio buttons, toggle switches, sliders, etc.) For example, in response to a user selecting a graphic icon for “loan duration”, member key program 110 may display a drop-down menu displaying options for the loan duration ranging from 30 days, three to six months, or up to one year.

In response to receive user selected options, member key program 110 may then generate and subsequently display an updated offer based on the selected terms. Continuing the above example, member key program 110 may update the original short term loan offer and adjust values of for each terms based on the user selected options. For example, in response to receiving a user selected option changing the loan duration from a longer duration (e.g., six-month period) to a shorter duration (e.g., three month period), member key program 110 may update the values for the other terms presented in the original offer (e.g., increase monthly payment, decrease total interest paid, decrease interest rate etc.).

In other aspects, member key program 110 may interface with other systems to generate one or more reports for the applicant (e.g., income verification reports, financial statement analysis, risk assessment, etc.). For example, member key program 110 leverage a model utilizing deep learning techniques to train, calculate weights, ingest inputs, and output a risk assessment analysis for a loan applicant.

In certain other aspects, member key program 110 may generate one or more notifications to the other systems and trigger one or more back-end updates to the one or more systems. For example, in instances where member key program 110 identifies keys as matching if they match a subset of characters, such as a subset identified as characters sufficient to connote membership, member key program 110 may generate a notification to the organization member key program 110 determines the applicant to be a member of to confirm the applicant's membership. In some instances, the generated notification may additionally trigger an update to the organization's system to generate a new key for that member. In other instances, the generated notification may trigger a request for updated membership documents.

FIG. 3 depicts a block diagram of components of computing systems within computing environment 100 of FIG. 1, in accordance with an aspect of the systems and methods of the present disclosure. It should be appreciated that FIG. 3 provides only an illustration of one implementation and does not imply any limitations with regard to the environments in which different embodiments may be implemented. Many modifications to the depicted environment may be made.

The programs described herein are identified based upon the application for which they are implemented in a specific embodiment. However, it should be appreciated that any particular program nomenclature herein is used merely for convenience, and thus aspects of the systems and methods disclosed herein should not be limited to use solely in any specific application identified and/or implied by such nomenclature.

Computer system 300 includes communications fabric 302, which provides communications between cache 316, memory 306, persistent storage 308, communications unit 610, and input/output (I/O) interface(s) 312. Communications fabric 302 may be implemented with any architecture designed for passing data and/or control information between processors (such as microprocessors, communications and network processors, etc.), system memory, peripheral devices, and any other hardware components within a system. For example, communications fabric 302 may be implemented with one or more buses or a crossbar switch.

Memory 306 and persistent storage 308 are computer readable storage media. In this embodiment, memory 306 includes random access memory (RAM). In general, memory 306 may include any suitable volatile or non-volatile computer readable storage media. Cache 316 is a fast memory that enhances the performance of computer processor(s) 304 by holding recently accessed data, and data near accessed data, from memory 306.

Member key program 110 (not shown) may be stored in persistent storage 308 and in memory 306 for execution by one or more of the respective computer processors 304 via cache 316. In an embodiment, persistent storage 308 includes a magnetic hard disk drive. Alternatively, or in addition to a magnetic hard disk drive, persistent storage 308 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Member key program 110 may be downloaded to persistent storage 308 through communications unit 310.

I/O interface(s) 312 allows for input and output of data with other devices that may be connected to computing device 102 and server computer 108. For example, I/O interface 312 may provide a connection to external devices 318 such as a keyboard, keypad, a touch screen, and/or some other suitable input device. External devices 318 may also include portable computer readable storage media such as, for example, thumb drives, portable optical or magnetic disks, and memory cards. Software and data used to practice aspects of the present disclosure may be stored on such portable computer readable storage media and may be loaded onto persistent storage 308 via I/O interface(s) 312. I/O interface(s) 312 also connect to a display 320.

Display 320 provides a mechanism to display data to a user and may be, for example, a computer monitor.

Aspects of the various systems and methods may be a system, a method, and/or a computer program product (CPP). Various aspects of the disclosure are described by narrative text, flowcharts, block diagrams of computer systems and/or block diagrams of the machine logic included in computer program product embodiments. With respect to any flowcharts, depending upon the technology involved, the operations may be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that may retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Aspects of the systems and methods of the present disclosure are described herein with reference to flowchart illustrations and/or block diagrams of methods, apparatus (systems), and computer program products according to aspects of the various systems and methods disclosed herein. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the systems and methods of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various aspects of the systems and methods of the present disclosure have been presented for purposes of illustration but are not intended to be exhaustive or limited to the embodiments disclosed. Many modifications and variations will be apparent to those of ordinary skill in the art without departing from the scope and spirit of aspects of the present disclosure. The terminology used herein was chosen to best explain the principles of the embodiment, the practical application or technical improvement over technologies found in the marketplace, or to enable others of ordinary skill in the art to understand the embodiments disclosed herein.

FIG. 4 depicts an alternate computing environment 400 illustrating components of computer 401 in accordance with an alternate embodiment. It should be appreciated that FIG. 4 provides only an illustration of one implementation and does not imply any limitations with regard to the environments in which different embodiments may be implemented. Many modifications to the depicted environment may be made.

Computing environment 400 contains an example of an environment for the execution of at least some of the computer code involved in performing the inventive methods, such as providing a unified solution that generates a key unique to the applicant based on extracted data elements from a set of records associated with the applicant that may be independently verified by a loan agency using the same set of records without having to share personally identifiable information which departs from conventional verification and authentication. Specifically, member key program 110 may receive a set of one or more records associated with an applicant and generate a key for the applicant based, at least in part, on extracted data elements from the set of one or more records. Member key program 110 may then determine membership status of the applicant to one or more organizations by comparing the generated key against a set of keys in a database and determine options for the applicant based on the membership status.

In addition to member key program 110, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and member key program 110, as identified above), peripheral device set 414 (including user interface (UI), device set 423, storage 424, and Internet of Things (IoT) sensor set 425), and network module 415. Remote server 104 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip”. In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in member key program 410 in persistent storage 413.

Communication fabric 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid-state storage devices. Operating system 422 may take several forms, such as various known proprietary operating systems or open-source Portable Operating System Interface type operating systems that employ a kernel. The code included in member key program 110 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that may be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods may typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 101 through WAN 102 to EUD 403. In this way, EUD 403 may display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 105 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs may be stored as “images”. A new active instance of the VCE may be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize all resources of that computer, such as connected devices, files and folders, network shares, CPU power, and quantifiable hardware capabilities. However, programs running inside a container may only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

Member key program 110 is a program, a subprogram of a larger program, an application, a plurality of applications, or mobile application software, which functions to provide a unified solution that may streamline the verification of credit union membership status for applicants seeking loans from different providers that may be independently verified by a loan agency using the same set of records without having to share personally identifiable information. In various embodiments, member key program 110 may implement the following steps: receiving, by one or more processors, a set of one or more records associated with an applicant; generating, by the one or more processors, a key for the applicant based, at least in part, on extracted data elements from the set of one or more records; determining, by the one or more processors, membership status of the applicant to one or more organizations by comparing the generated key against a set of keys in a database; and determining, by the one or more processors, options for the applicant based on the membership status. In the depicted embodiment, member key program 110 is a standalone software program. In another embodiment, the functionality of member key program 110, or any combination programs thereof, may be integrated into a single software program. In some embodiments, member key program 110 may be located on separate computing devices (not depicted) but may still communicate over WAN 402. In various embodiments, client versions of member key program 110 resides on any other computing device (not depicted) within computing environment 400. In the depicted embodiment, member key program 110 includes model 152 and may leverage model 452 to generate unique member keys.

Model 452 is representative of a model utilizing deep learning techniques to train, calculate weights, ingest inputs, and output a plurality of solution vectors. In an embodiment, model 452 is comprised of any combination of deep learning model, technique, and algorithm (e.g., decision trees, Naive Bayes classification, support vector machines for classification problems, random forest for classification and regression, linear regression, least squares regression, logistic regression). In an embodiment, model 452 utilizes transferrable neural networks algorithms and models (e.g., long short-term memory (LSTM), deep stacking network (DSN), deep belief network (DBN), convolutional neural networks (CNN), compound hierarchical deep models, etc.) that may be trained with supervised or unsupervised methods. In the depicted embodiment, model 452 is a recurrent neural network (RNN) trained utilizing supervised training methods.

Aspects of the present disclosure may contain various accessible data sources, such as database 454, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Member key program 110 may provide informed consent, with notice of the collection of personal data, allowing the user to opt in or opt out of processing personal data. Consent may take several forms: opt-in consent imposes on the user to take an affirmative action before the personal data is processed, alternatively, opt-out consent imposes on the user to take an affirmative action to prevent the processing of personal data before the data is processed. Member key program 110 enables the authorized and secure processing of user information, such as tracking information, as well as personal data, such as personally identifying information or sensitive personal information. Member key program 110 may provide information regarding the personal data and the nature (e.g., type, scope, purpose, duration, etc.) of the processing. Member key program 110 may provide the user with copies of stored personal data. Member key program 110 may allow the correction or completion of incorrect or incomplete personal data. Member key program 110 may allow the immediate deletion of personal data.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware may be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for determining eligibility based on membership, comprising:
receiving, by one or more processors, a set of one or more records associated with an applicant;
generating, by the one or more processors, a key for the applicant based, at least in part, on extracted data elements from the set of one or more records;
determining, by the one or more processors, membership status of the applicant to one or more organizations by comparing the generated key against a set of keys in a database; and
determining, by the one or more processors, options for the applicant based on the membership status.

2. The computer-implemented method of claim 1, wherein determining, by the one or more processors, membership status of the applicant to one or more organizations by comparing the generated key against a set of keys in a database comprises:
locating, by the one or more processors, an identical key in the set of keys in the database to the generated key for the applicant, wherein the identical key indicates membership status.

3. The computer-implemented method of claim 1, wherein determining options for the applicant based on the membership status comprises:
determining, by the one or more processors, eligibility and terms based on the membership status of the applicant to at least one organization of the one or more organizations.

4. The computer-implemented method of claim 1, wherein generating, by the one or more processors, the key for the applicant based, at least in part, on extracted data elements comprises generating, by the one or more processors, an ordered combination of a subset of characters identified from the extracted data elements.

5. The computer-implemented method of claim 4, wherein generating an ordered combination of a subset of characters identified from the extracted data elements comprises:
identifying, by the one or more processors, categories of data elements associated with the member;
identifying, by the one or more processors, characters for each identified category;
selecting, by the one or more processors, a subset of the identified characters from each identified category; and
ordering, by the one or more processors, the selected subset of identified characters.

6. The computer-implemented method of claim 4, wherein the categories of data elements comprise a social security number, an address, and a date of birth of the member.

7. The computer-implemented method of claim 1, further comprising:
locating a second key for the applicant in the set of keys in the database that indicates a secondary status based on an ordered combination of a subset of characters identified from the extracted data elements.

8. The computer-implemented method of claim 7, further comprising:
determining, by the one or more processors, eligibility and terms based on the secondary status of the applicant.

9. A computer program product for determining eligibility based on membership, comprising:
one or more computer readable storage media and program instructions stored on the one or more computer readable storage media, the program instructions comprising:
program instructions to receive a set of one or more records associated with an applicant;
program instructions to generate a key for the applicant based, at least in part, on extracted data elements from the set of one or more records;
program instructions to determine membership status of the applicant to one or more organizations by comparing the generated key against a set of keys in a database; and
program instructions to determine options for the applicant based on the membership status.

10. The computer program product of claim 9, wherein the program instructions to determine membership status of the applicant to one or more organizations by comparing the generated key against a set of keys in a database comprise:
program instructions to locate an identical key in the set of keys in the database to the generated key for the applicant, wherein the identical key indicates membership status.

11. The computer program product of claim 9, wherein the program instructions to determine options for the applicant based on the membership status comprise:
program instructions to determine eligibility and terms based on the membership status of the applicant to at least one organization of the one or more organizations.

12. The computer program product of claim 9, wherein the program instructions to generate the key for the applicant based, at least in part, on extracted data elements comprise program instructions to generate an ordered combination of a subset of characters identified from the extracted data elements.

13. The computer program product of claim 12, wherein the program instructions to generate an ordered combination of a subset of characters identified from the extracted data elements comprise:
program instructions to identify categories of data elements associated with the member;
program instructions to identify characters for each identified category;
program instructions to select a subset of the identified characters from each identified category; and
program instructions to order the selected subset of identified characters.

14. The computer program product of claim 12, wherein the categories of data elements comprise a social security number, an address, and a date of birth of the member.

15. The computer program product of claim 9, wherein the program instructions stored on the one or more computer readable storage media further comprise:
program instructions to locate a second key for the applicant in the set of keys in the database that indicates a secondary status based on an ordered combination of a subset of characters identified from the extracted data elements.

16. The computer program product of claim 15 wherein the program instructions stored on the one or more computer readable storage media further comprise:
program instructions to determine eligibility and terms based on the secondary status of the applicant.

17. A computer system for determining eligibility based on membership, comprising:
one or more computer processors;
one or more computer readable storage media; and
program instructions stored on the one or more computer readable storage media for execution by at least one of the one or more computer processors, the program instructions comprising:
program instructions to receive a set of one or more records associated with an applicant;
program instructions to generate a key for the applicant based, at least in part, on extracted data elements from the set of one or more records;
program instructions to determine membership status of the applicant to one or more organizations by comparing the generated key against a set of keys in a database; and
program instructions to determine options for the applicant based on the membership status.

18. The computer system of claim 17, wherein the program instructions to determine membership status of the applicant to one or more organizations by comparing the generated key against a set of keys in a database comprise:
program instructions to locate an identical key in the set of keys in the database to the generated key for the applicant, wherein the identical key indicates membership status.

19. The computer system of claim 17, wherein the program instructions to determine options for the applicant based on the membership status comprise:
program instructions to determine eligibility and terms based on the membership status of the applicant to at least one organization of the one or more organizations.

20. The computer system of claim 17, wherein the program instructions to generate the key for the applicant based, at least in part, on extracted data elements comprise program instructions to generate an ordered combination of a subset of characters identified from the extracted data elements.
